(19) United States
(12) Patent Application Publication
(10) Pub. No.: US 2026/0268400 A1
(43) Pub. Date: Sep. 10, 2026

(54) CRYPTO BASED MONETARY SYSTEM OF TRADE WITH PROTOCOL ENFORCED CROSS CHAIN ATOMIC SETTLEMENT

(71) Applicant: Swopblock LLC, Martinsburg, PA (US)

(72) Inventor: Jeff Jay Hilde, Martinsburg, PA (US)

(21) Appl. No.: 19/368,887

(22) Filed: Oct. 24, 2025

Related U.S. Application Data
(63) Continuation-in-part of application No. 18/146,716, filed on Dec. 27, 2022, now abandoned.

(51) Int. Cl. G06Q 40/04; G06Q 20/38

(52) U.S. Cl. CPC G06Q 40/04; G06Q 20/381; G06Q 20/389

(57) ABSTRACT

The disclosed system operates across first and second blockchains. An exchange medium resides at native addresses on each. Nodes bind declared face value to a base cryptocurrency and reassign it between base cryptocurrencies while preserving total declared face value. Wallets submit buy and sell reservations that place protocol holds on identified amounts. A single signed fill references the reservations and, when validated, simultaneously disburses the held exchange medium and delivers a native asset. A relay consensus computes relay proofs from participating networks, selects a maximum proof that satisfies a release threshold, and triggers release of all holds without time locks or custodial bridges. Orders may expire by market volume. Peer to peer dissemination and on chain events render activity observable while enabling atomic cross chain settlement and inter crypto face value migration.

### CROSS-REFERENCE TO RELATED APPLICATIONS

The present application claims priority to U.S. Nonprovisional application Ser. No. 18/146,716 filed Dec. 27, 2022, titled “REAL-TIME MULTIPLE-ACCESS EXCHANGE-PARTY-FREE COUNTERPARTY-SECURE EXCHANGE,” which is hereby incorporated by reference in its entirety.

### TECHNICAL FIELD

The embodiments generally relate to the technical field of systems and methods for decentralized, cross chain cryptocurrency exchange and settlement.

### BACKGROUND

Conventional cryptocurrency exchanges operate through centralized infrastructure that aggregates liquidity and custody under a single administrative domain. User devices interact with an exchange service that manages order intake, matching, and settlement while also holding customer assets. Communication channels convey bid and ask data and transmit confirmations, yet custody and processing remain coordinated by the central operator. This architecture concentrates exchange management and asset handling within the exchange environment.

Decentralized exchanges introduced smart contract based liquidity that executes on public blockchains. In many implementations, interconnected contracts distribute liquidity and enable token swaps while users interact from cryptographic wallets. For movement across distinct blockchain networks, these systems often depend on a bridge component that coordinates cross chain transfers. The bridge functions as an external coordination point that links otherwise independent ledgers and becomes a necessary service for cross chain execution.

Other cross chain approaches employ server orchestration to conduct sequences of conversions across multiple venues. Representative systems leverage centralized services to select conversion paths, manage temporary custody, and synchronize the legs of a multi market transaction. Because independent networks confirm activity on their own schedules, these approaches address coordination through external control that manages timing across the separate ledgers.

Protocols based on hash time locked contracts enable atomic swaps by requiring a secret revelation within defined time windows. These mechanisms associate related transactions on different blockchains and attempt to ensure that each completes only if the other does. Reliance on timeouts and network timing can still produce incomplete exchanges when delays or implementation issues arise, so participants design operational safeguards around those timing behaviors.

Blockchain technology has also been applied to securities settlement within a single or hierarchical ledger to accelerate clearing and reduce double spending risk. Such systems use cryptographically signed instructions and block creation to support near real time gross settlement. Coordinating transfers that span multiple independent blockchains remains outside the scope of these single ledger solutions and relies on additional mechanisms for inter system synchronization.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

This summary is provided to introduce a variety of concepts in a simplified form that is further disclosed in the detailed description of the embodiments. This summary is not intended for determining the scope of the claimed subject matter. The disclosed system establishes a crypto based monetary system of trade that assigns a declared face value to a base cryptocurrency at a native address and relocates that face value across heterogeneous base cryptocurrencies using a new exchange medium that is locatable on multiple blockchains. The approach operates without a trusted counterparty or a trusted third party and frames exchange as protocol governed value reassignment that remains auditable on chain.

The disclosed system conducts exchange using a three message reservation model in which a buy reservation locates a payment amount of the exchange medium at a selectable native address, a sell reservation locates collateral of the exchange medium and binds a delivery quantity of a native asset, and a single fill message simultaneously disburses the payment and delivers the native asset. Each reservation and the fill transmits as a separately signed blockchain transaction message so participants maintain control of their private keys while peers propagate the orders. This structure addresses cross network coordination by completing both sides of the trade with one verified fill rather than with loosely sequenced transfers.

Protocol enforced holds attach to amounts of the exchange medium referenced in open reservations and remove owner driven transferability until release conditions are met. A relay consensus mechanism computes relay proof values on participating networks, selects a maximum relay proof that satisfies a configured threshold, and releases the holds only upon broadcast of that maximum, thereby enabling atomic settlement across independent ledgers without hash time locked contracts. Implementations can derive the relay proof from proofs of stake and proofs of work and combine them into a scalar value for maximum selection. These operations overcome timing sensitivity and external orchestration seen in conventional cross chain techniques by tying release to cross network confirmation progress rather than to time windows or servers.

Orders expire based on a market volume criterion that invalidates unmatched reservations when cumulative traded volume of the exchange medium reaches a specified threshold. This behavior returns held amounts to owner control without relying on wall clock deadlines and supports high speed activity even during network variability. The volume based expiration removes dependency on time based constraints that conventional designs employ and avoids liveness failures caused by delay.

Peer to peer messaging publishes orders directly between user devices, and execution proceeds without an off chain order routing server or bridge. Native addresses can maintain internal ledgers for the exchange medium alongside native assets, and in some embodiments a smart contract commingles both at a single on chain address while still operating under the same hold and release rules. The disclosed system supports non preselected counterparties and sequential divisional fills so a live order can clear in parts across multiple addresses, and it preserves transparency by recording events on participating chains. These elements address limitations of centralized custody and external bridges by eliminating a single orchestrating entity and by making cross chain settlement a protocol effect observable on chain.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a method for inter crypto face value migration and relocation executed by nodes of the disclosed system across a first blockchain network and a second blockchain network, according to some embodiments;

FIG. 4 illustrates a reservation posting flow executed by application program to initiate exchange using the exchange medium, according to some embodiments;

FIG. 5 illustrates a hold placement and enforcement flow performed by the hold manager 230 to restrict transferability of amounts of the exchange medium referenced by a posted reservation, according to some embodiments;

FIG. 6 illustrates a fill assembly and validation flow performed by application program to consummate exchange between posted reservations, according to some embodiments;

FIG. 7 illustrates a relay consensus processing flow executed by relay consensus module to determine when protocol holds may be released for a fill, according to some embodiments;

FIG. 8 illustrates an atomic release and settlement flow performed after relay consensus module signals that a fill has satisfied a release threshold, according to some embodiments; and

FIG. 9 illustrates a volume based invalidation flow executed to retire unmatched reservations without relying on wall clock timers, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system operates across first and second blockchains. An exchange medium resides at native addresses on each. Nodes bind declared face value to a base cryptocurrency and reassign it between base cryptocurrencies while preserving total declared face value. Wallets submit buy and sell reservations that place protocol holds on identified amounts. A single signed fill references the reservations and, when validated, simultaneously disburses the held exchange medium and delivers a native asset. A relay consensus computes relay proofs from participating networks, selects a maximum proof that satisfies a release threshold, and triggers release of all holds without time locks or custodial bridges. Orders may expire by market volume. Peer to peer dissemination and on chain events render activity observable while enabling atomic cross chain settlement and inter crypto face value migration.

A representative deployment operates across at least two independent blockchain networks and uses an exchange medium that may be located at native addresses on each participating network. The disclosed system treats the exchange medium as a blockchain resident unit of account and assigns declared face value to distinct base cryptocurrencies while preserving a total declared face value across networks. A user device may interact with wallet software to create orders that reference the exchange medium and one or more base cryptocurrencies, and nodes on the participating networks may process those orders to complete exchange without reliance on a trusted counterparty or a trusted third party.

Each blockchain network in the deployment may supply a consensus mechanism such as proof of work or proof of stake and a native addressing model capable of receiving and transferring assets. The exchange medium may be realized as a native asset or as a smart contract token, and each supported chain may maintain a ledger state that includes balances of the exchange medium at native addresses. A native address on a given chain may also hold balances of a chain specific base cryptocurrency so that the exchange medium and the base cryptocurrency remain observable together for accounting and auditing purposes.

Nodes that participate in one or more supported chains may include processors, volatile and nonvolatile memory, and network interfaces that exchange messages with peers. Executable software on those nodes may include a reservation subsystem, a fill execution engine, a hold manager, a relay consensus module, and a ledger service. The reservation subsystem may parse and validate orders from wallets, the fill execution engine may assemble and verify a single fill message that references those orders, the hold manager may restrict spend paths for amounts of the exchange medium, the relay consensus module may compute and evaluate relay proofs across chains, and the ledger service may emit final state transitions to the underlying chains.

The disclosed system uses a three message exchange that consists of a buy reservation, a sell reservation, and a fill. A buy reservation may locate an amount of the exchange medium at a selected native address and indicate a target quantity of a base cryptocurrency to receive. A sell reservation may locate a collateral amount of the exchange medium at a selected native address and bind a delivery quantity of a base cryptocurrency to deliver upon execution. The fill may reference both reservations and complete two transfers in one action by disbursing the exchange medium from buyer to seller and delivering the base cryptocurrency from seller to buyer.

Wallet software may generate each message with an independent digital signature produced by a secret key under the control of the wallet operator. Nodes that receive the messages may validate signatures, verify that referenced addresses exist on the indicated chains, and enforce consistency rules such as non reuse of reservation identifiers and correctness of amounts. The messages may propagate through the same peer to peer “gossip” (communication or messaging to neighboring nodes) used by the underlying blockchains so that discovery and execution occur transparently. In the disclosed system, nodes may gossip reservation messages, fill proposals, and relay proof bundles across participating blockchains. A wallet submits a signed reservation to one peer, that peer forwards to a few others, and within a short time most validators see the reservation. The same pattern distributes a fill and the accompanying proof bundle so independent validators can verify and, when appropriate, release holds. Gossip here provides a simple, fault tolerant way to disseminate state needed for atomic cross chain settlement without using a centralized routing service.

Each reservation may place a protocol hold on an amount of the exchange medium at the selected native address. The hold manager may mark those amounts non transferable by the owner until a valid fill releases the hold. A hold record may include a reservation identifier, the amount held, a reference to the native address that hosts the balance, and an authorization set that identifies who may sign a releasing fill. On smart contract based chains, the hold may be enforced by contract state that blocks transfers of the held amount except to a release function that validates a fill. On UTXO based chains, the hold may be enforced by a locking script that references a fill identifier and a relay proof attestation.

A relay consensus module may coordinate cross network release. The module may collect evidence that each participating network has confirmed the transactions associated with the fill and may compute a relay proof value for each network. A relay proof may encode measures such as accumulated proof of work difficulty or the number and weight of stake attestations. Nodes may exchange relay proofs with peers, select a maximum relay proof that satisfies a configured threshold, and publish the maximum value to all parties. The hold manager may release held amounts only upon receipt of a maximum relay proof that meets or exceeds the threshold.

The single fill message may carry identifiers for the referenced buy and sell reservations, destination addresses for the outgoing disbursement of the exchange medium and the delivery of the base cryptocurrency, and the relay proof bundle that validators can check. The fill execution engine may perform deterministic validation that includes verifying both reservation signatures, verifying that the specified holds exist and match the amounts, and verifying that the relay proof bundle can produce a maximum that satisfies the release threshold. The engine may then emit a result that each chain encodes into its transaction set so the disbursement and delivery finalize in one atomic action.

Inter crypto face value migration and relocation may occur when a user chooses to reassign a declared face value from a first base cryptocurrency to a second base cryptocurrency. The ledger service may record a reassignment by sequestering or burning an assignment associated with the first base cryptocurrency and minting or freeing a corresponding assignment associated with the second base cryptocurrency according to a valuation model expressed in the order. The total declared face value across chains may remain constant, and the ledger may expose events that auditors can verify to confirm that the reassignment preserved integrity.

Orders may expire based on a market volume criterion rather than a wall clock interval. Each reservation may include a market volume threshold that states the cumulative traded volume of the exchange medium at which the order becomes invalid. Nodes may maintain a rolling measure of traded volume for the exchange medium and may compare that measure to the threshold when processing candidate fills. If cumulative volume reaches the threshold before a fill completes, nodes may mark the reservation invalid, release any holds tied to the reservation, and stop considering the reservation for matching.

Sequential divisional fills may allow a single reservation to clear against multiple non preselected counterparties. The reservation subsystem may admit multiple fills that reference disjoint portions of the reservation amounts as long as each fill carries independently valid signatures and relay proofs. The ledger service may reduce the remaining held amount after each accepted fill and may emit partial completion events until the reservation is fully satisfied or invalidated by the volume threshold.

The system may operate without an off chain order routing server. Wallets may submit reservations directly to blockchain peers, and validators may gossip candidate fills that they assemble or receive from other participants. This server less approach may remove reliance on bridge guardians or routing wardens and may keep execution observable through on chain or peer visible artifacts. Nodes may still index messages for local efficiency and may expose APIs so explorers and compliance tools can reconstruct markets from the published messages.

Native addresses that host the exchange medium may also host a base cryptocurrency balance. On account based chains, a smart contract may record a mapping from address to exchange medium balance and a separate mapping for hold amounts with flags that indicate active or released states. On UTXO based chains, unspent outputs that represent the exchange medium may carry metadata that identifies held or free status. In both models, the hold manager may update state when a reservation posts or when a fill releases the hold.

The relay consensus module may implement a communication protocol that ensures liveness and agreement on the maximum relay proof. Nodes may produce local proofs for observed chain progress, relay those proofs to peers, and adopt the largest proof they observe that remains consistent with chain headers and attestation sets. A node that observes a maximum relay proof that satisfies the threshold may sign and broadcast a release attestation that the hold manager accepts as a sufficient condition to release held amounts referenced by the fill.

The computing environment may include a processor that executes instructions stored in memory to perform message parsing, signature verification, hold state transitions, relay proof computation, and ledger updates. Storage may persist reservation records, hold records, and fill confirmations in append only logs that support replay after restart. Network interfaces may support encrypted peer channels and chain specific transaction interfaces. The software may be packaged as modules that link with chain clients or run alongside them with remote procedure calls.

Message formats may use compact binary encodings to limit bandwidth and latency. A reservation may include a unique identifier, a chain identifier for the address that hosts the exchange medium, an asset descriptor for the base cryptocurrency to receive or deliver, an amount of the exchange medium to hold as payment or collateral, a market volume threshold for expiration, and a signature over those fields. A fill may include references to the paired reservations, destination addresses for disbursement and delivery, amounts, a relay proof bundle, and a signature. Nodes may reject messages that lack required fields, carry invalid signatures, or reference unknown reservations or addresses.

Security may arise from layered checks. Digital signatures may authenticate the origin of reservations and fills. The hold manager may remove owner ability to transfer a held amount of the exchange medium until a valid fill arrives, which may prevent a malicious wallet from redirecting the held amount while a reservation remains open. The relay consensus module may demand cross network confirmation progress before release, which may block asymmetric settlement where one side clears and the other remains reversible.

A typical exchange may proceed with a buyer posting a buy reservation that places a payment amount of the exchange medium on hold at a native address on a first chain. A seller may post a sell reservation that places a collateral amount of the exchange medium on hold at a native address on a second chain and binds a delivery quantity of a base cryptocurrency. A network participant may construct a fill that references the reservations, specify destination addresses, and include a relay proof bundle. Validators may verify the fill and propagate it to both chains, after which the relay consensus module may publish a maximum relay proof that causes both holds to release and both transfers to finalize.

In some embodiments the exchange medium may be referred to as a portable unit that aggregates exchange intent across chains. Nodes may compute composite relay proofs derived from multiple consensus sources and may use a simple scalar comparison to decide when to release holds. This approach may unify cross chain accounting and release conditions so that participants observe a single event that both chains recognize as sufficient to finalize disbursement and delivery.

A cross chain banking mode may treat deposits as reservations that hold exchange medium balances until a loan or redemption fill executes. A cross chain auction mode may treat bids as buy reservations and winning allocations as fills that disburse the exchange medium and deliver auctioned assets to multiple winners in divisional lots. A cross chain vending mode may treat inventory commitments as sell reservations and may execute fills upon purchase to release payment and item delivery together. These modes may reuse the same primitives of holds, relay proofs, and single message fills.

Implementations may define valuation models that govern reassignment of declared face value during inter crypto migration and relocation. A model may reference observed exchange ratios between base cryptocurrencies or may read an index published on chain. When a user requests reassignment, nodes may compute a corresponding assignment amount on the destination base cryptocurrency and may update the ledger so that the total declared face value remains constant. Events may record the reassignment so that external observers can trace the path of value across chains.

The system may include failure handling. If cumulative traded volume reaches a reservation's threshold before a fill produces a sufficient maximum relay proof, nodes may cancel the pending match and clear all related holds. If a chain reorganizes, nodes may recompute relay proofs and withhold release until the new maximum again satisfies the threshold. If a node cannot contact peers, it may continue to accept reservations locally and may defer fill execution until connectivity returns.

Performance considerations may include batching of attestations that contribute to relay proofs, parallel verification of signatures for reservations and fills, and compact encodings to minimize message size. Nodes may cache recent relay proofs and address states to reduce repeated computation. Operators may tune the release threshold to balance speed and finality across participating chains.

A software development kit may expose functions to construct reservations, to sign and submit fills, and to subscribe to events that report holds, releases, and reassignment results. The kit may include reference implementations for both account based and UTXO based chains so that integrators can adapt the exchange medium and hold logic to differing chain models. Documentation may describe how to register a new chain by deploying the exchange medium representation and by implementing hold and release primitives that the hold manager and relay consensus module can call.

Privacy layers may be optional. Message payloads may include commitments to amounts or addresses while still exposing relay proofs and state changes that peers can validate. Auditors may reconcile committed values with later disclosures without altering the release condition, since the hold manager may rely on the relay consensus outcome rather than on the cleartext contents of reservation payloads.

The system may also include monitoring and explorer components that reconstruct order books and fills from published messages. Because reservations and fills may propagate through blockchain peers and may be encoded as on chain transactions or messages in chain native inboxes, observers may follow market activity without privileged access. Nodes may emit structured events that include reservation identifiers, hold state changes, fill acceptance, and relay proof maximum announcements.

To extend the deployment, operators may add a new chain by instantiating the exchange medium on that chain and by providing a mapping from the chain's consensus outputs to a relay proof contribution. The relay consensus module may accept those contributions and compute maxima that consider the new chain along with existing ones. Wallets may start posting reservations that reference native addresses on the new chain, and fills may include transfers to or from the new chain without changing the three message reservation and fill model.

Various implementations of the invention involve the technical field of decentralized, cross chain cryptocurrency exchange and settlement including hosting an exchange medium at native addresses on a first blockchain network and on a second blockchain network; assigning a declared face value to a first base cryptocurrency at a first native address; receiving an order that requests relocation of value to a second base cryptocurrency; transferring an amount of the exchange medium from a native address on the first blockchain network to a native address on the second blockchain network; reassigning the declared face value from the first base cryptocurrency to the second base cryptocurrency while preserving a total declared face value recorded across the first and second blockchain networks; and publishing events that render the reassignment auditable without a centralized matching engine or bridge server and are therefore necessarily rooted in computer technology. For example, the aforementioned steps are inherently computer-based and cannot be performed in the human mind. The present invention amounts to more than merely implementing the generic computer as a tool to gather, analyze, and output data because the steps of the present method, system, or product improve the decentralized, cross chain cryptocurrency exchange and settlement by replacing external coordination and timing windows with protocol operations that run across independent ledgers. Nodes host an exchange medium at native addresses on multiple blockchains and maintain internal ledgers for that medium alongside native assets, so value movement and accounting occur on chain rather than through a bridge or server. A buy reservation, a sell reservation, and a fill execute as separately signed blockchain messages; the fill enforces atomic settlement so all transfers succeed together or revert together, and unmatched orders can expire by a market volume threshold rather than a timer. The system ties release of protocol holds to a relay consensus that computes relay proofs on participating networks, selects a maximum proof that satisfies a threshold, and releases holds only when that maximum propagates, without using hash time locked contracts. These operations employ cryptographic signatures, on chain state flags, and consensus derived proofs implemented by networked processors, which constitute specific machine functionality rather than a method of organizing human activity. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

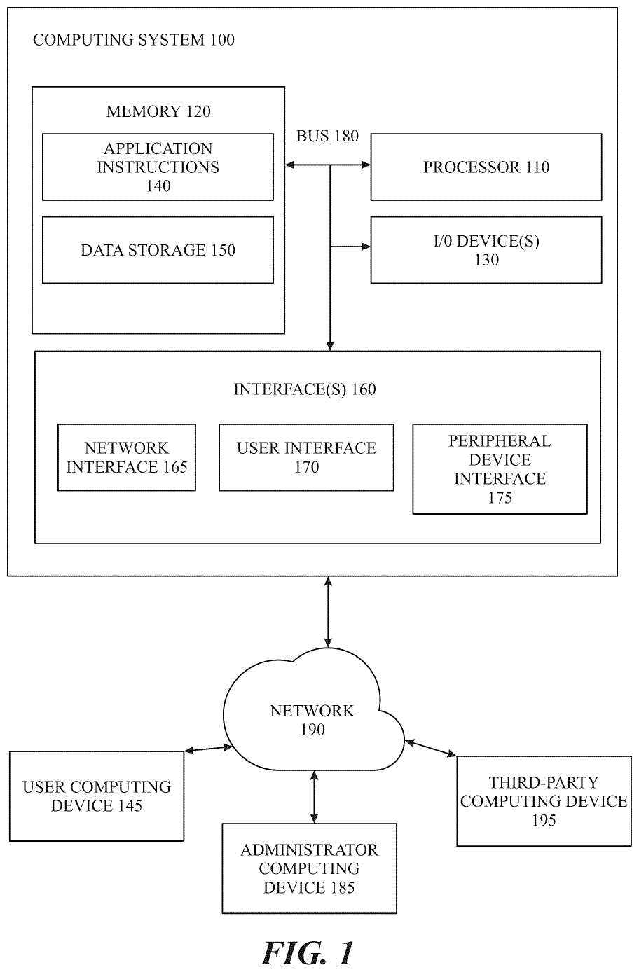

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

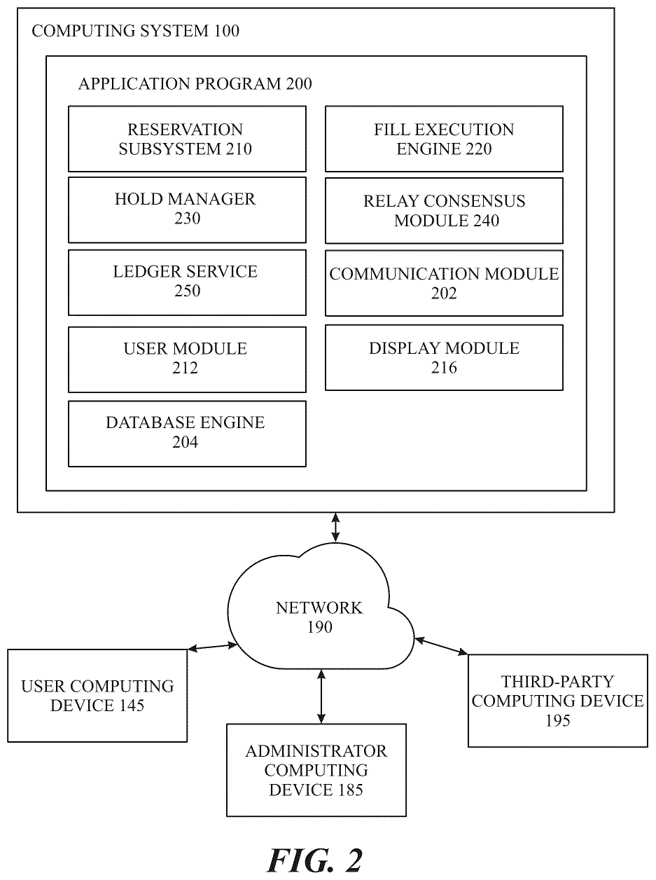

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a reservation subsystem 210, a fill execution engine 220, a hold manager 230, a relay consensus module 240, a ledger service 250 a communication module 202, a database engine 204, a user module 212, and a display module 216.

In some embodiments, the reservation subsystem 210 is configured to construct, validate, persist, and disseminate buy and sell reservations that initiate exchange using the exchange medium on multiple blockchains. The subsystem may operate within application program 200 on computing system 100 and interact with user module 212 to obtain order intent from a wallet or operator. It may encode each reservation as a deterministic message that includes a unique reservation identifier, a chain identifier for the native address that hosts the exchange medium, an asset descriptor for the base cryptocurrency to be received or delivered, an amount of the exchange medium to be held as payment or collateral, optional destination hints, and a market volume threshold for expiration. The subsystem may canonicalize the message using a compact binary format, generate or verify a digital signature such as Ed25519 or secp256k1 over the canonical form, and reject any message that fails schema or signature checks.

In some embodiments, the reservation subsystem 210 is configured to coordinate hold placement through the hold manager 230. When a buy reservation posts, the subsystem may request creation of a protocol hold on the specified payment amount of the exchange medium at the indicated native address. When a sell reservation posts, the subsystem may request a protocol hold on the specified collateral amount and record a delivery quantity for the native asset. The reservation record may include a pointer to the hold record so that later fills can be checked against the exact amounts placed on hold. On account based chains, the subsystem may call a contract method to set hold flags in on chain state. On UTXO based chains, it may cause creation of a locking script that prevents movement of the held amount except by a valid fill that references the reservation identifier.

In some embodiments, the reservation subsystem 210 is configured to enforce anti replay and eligibility rules so only live reservations participate in matching. The subsystem may maintain per address nonces and check that a reservation identifier has not been reused. It may verify that the amount fields are positive, that listed addresses exist on the referenced chain, and that the signer controls the spend path for the native address that hosts the exchange medium. It may consult ledger service 250 to confirm that the requested hold fits the current balance and that no conflicting hold consumes the same units. If any rule fails, the subsystem may return a keyed rejection reason to the user module 212 and avoid broadcasting the reservation.

In some embodiments, the reservation subsystem 210 is configured to publish and discover reservations using communication module 202. After successful validation and hold placement, the subsystem may serialize the reservation and broadcast it over peer to peer channels native to the participating blockchains. It may also subscribe to inbound reservation gossip from other nodes and apply the same validation path before accepting a remote reservation into the local order pool. The subsystem may attach metadata that indicates discovery time, observed peers, and chain height at acceptance so later audit can reconstruct the order flow without an off chain routing server.

In some embodiments, the reservation subsystem 210 is configured to support sequential divisional fills and non preselected counterparties. The subsystem may expose an iterator over live reservations that the fill execution engine 220 can use to assemble one or more fills that each consume a disjoint portion of a reservation. After a partial fill finalizes, the subsystem may decrement the remaining held amount, update the reservation state, and keep the reservation available until the remaining amount becomes zero or an invalidation condition occurs. The subsystem may track per reservation counters for filled amounts to prevent overfill across concurrent proposals.

In some embodiments, the reservation subsystem 210 is configured to implement market volume based expiration. The subsystem may read a rolling measure of cumulative traded volume for the exchange medium maintained by ledger service 250 and compare that measure to the volume threshold stored in each reservation. When cumulative volume meets or exceeds the threshold, the subsystem may mark the reservation invalid, instruct hold manager 230 to clear associated holds, and remove the reservation from the matching set. This approach may avoid reliance on wall clock timers and may adapt naturally to bursts of network activity.

In some embodiments, the reservation subsystem 210 is configured to persist durable state through database engine 204. The subsystem may store each reservation in an append only log with fields for identifiers, amounts, signatures, hold pointers, expiration thresholds, and state transitions such as posted, partially filled, fully filled, or invalidated. On restart, the subsystem may replay the log to restore the live order pool and reattach to any holds that remain active on participating chains. The subsystem may index reservations by asset descriptor, hosting chain, and address so explorers and compliance tools can query activity efficiently.

In some embodiments, the reservation subsystem 210 is configured to provide telemetry and user feedback through display module 216. The subsystem may emit events when a reservation posts, when a hold is placed or released, when a partial fill reduces the remaining amount, and when market volume invalidates the reservation. The user module 212 may present these events to the operator and may allow cancellation requests that the subsystem converts into messages that release holds when protocol rules permit. Through these interactions the subsystem supplies the data that the fill execution engine 220 and relay consensus module 240 later use to finalize atomic cross chain settlement.

In some embodiments, the fill execution engine 220 is configured to assemble, authorize, and finalize a single fill that consummates exchange between a posted buy reservation and a posted sell reservation. The engine may run within application program 200 on computing system 100 and may treat a fill as a deterministic transaction package that references both reservations, identifies destination addresses for disbursement of the exchange medium and delivery of the native asset, and carries a relay proof bundle. The engine may receive candidate reservations from the reservation subsystem 210, select compatible pairs based on asset descriptors and amounts, and construct a proposed fill that consumes only the available held amounts. To prevent race conditions, the engine may lock each reservation record while constructing a fill and release the locks after commit or rollback.

In some embodiments, the fill execution engine 220 is configured to validate authorizations and preconditions before publishing a fill. The engine may verify digital signatures on both reservations and on the fill itself using elliptic curve cryptography such as secp256k1 or Ed25519. The engine may request the hold manager 230 to confirm that protocol holds exist at the referenced native addresses and that the held amounts match the fill amounts. The engine may also query ledger service 250 to confirm address existence, nonces, and spend paths appropriate to account based or UTXO based chains. When divisional matching occurs, the engine may compute partial amounts that respect remaining held balances and write idempotent sequence numbers so repeated submissions cannot overfill a reservation.

In some embodiments, the fill execution engine 220 is configured to coordinate cross network release using relay consensus module 240. The engine may attach a relay proof bundle to the fill, where the bundle includes proofs derived from consensus outputs of participating networks. The engine may invoke the relay consensus module 240 to compute a maximum relay proof and to evaluate the maximum against a configured threshold. If the maximum meets or exceeds the threshold, the engine may instruct hold manager 230 to release the holds referenced in the fill. If the maximum does not satisfy the threshold, the engine may keep the fill pending and continue to observe updated proofs until release becomes permissible or a reservation becomes invalid under market volume rules.

In some embodiments, the fill execution engine 220 is configured to publish the fill into both chains and to drive on chain state transitions to completion. The engine may serialize the fill into chain native transactions or inbox messages and submit them through communication module 202. The engine may monitor both chains for acceptance signals such as transaction receipts, inclusion in a block, or confirmation depth and may record these observations in database engine 204. After holds are released, the engine may cause disbursement of the exchange medium to the seller's destination address and delivery of the native asset to the buyer's destination address and may request ledger service 250 to emit finalization events that explorers and compliance tools can consume.

In some embodiments, the fill execution engine 220 is configured to handle reorganization, failure, and fee management. The engine may detect chain reorganization and recompute relay proofs via module 240 before any release action. The engine may ensure that a fill either completes fully or reverts fully by treating the pair of transfers as a single atomic operation governed by the release condition. The engine may estimate transaction fees or gas for each chain, include fee paying inputs or allowances where required, and adjust non critical parameters such as destination hints without altering the cryptographically bound amounts. If a submission fails due to fee shortfall or transient network error, the engine may retry with updated fee parameters while preserving the same fill identifier to maintain idempotence.

In some embodiments, the fill execution engine 220 is configured to support sequential divisional fills against non preselected counterparties. The engine may repeatedly evaluate the live reservation pool, compute compatible partial fills that reference disjoint subsets of a reservation, and publish each fill as a self contained transaction package. After each accepted fill, the engine may decrement remaining held amounts and update reservation state in database engine 204. Throughout these operations the engine may expose status and telemetry to user module 212 and display module 216, including pending, released, finalized, or invalidated states, so operators can observe progress of atomic cross chain settlement.

In some embodiments, the hold manager 230 is configured to create, enforce, and release protocol holds on identified amounts of the exchange medium at native addresses on participating blockchains. The hold manager may run within application program 200 on computing system 100 and may receive requests from reservation subsystem 210 to place holds that remove owner driven transferability from payment amounts for buy reservations and collateral amounts for sell reservations. The hold manager may allocate a hold record that includes a reservation identifier, a hosting chain identifier, a native address, an amount of the exchange medium, an authorization set that identifies acceptable fill signers, and a current state flag that may be active, released, or cleared.

In some embodiments, the hold manager 230 is configured to enforce holds using the primitive controls available on each chain type. On account based chains, the hold manager may call a smart contract method that updates on chain mappings for balances and hold amounts and sets a bit field that blocks transfers of the held amount except through a release function that verifies a referenced fill. On UTXO based chains, the hold manager may produce a locking script that commits to the reservation identifier and to an authorization script path that becomes spendable only when a fill provides required signatures and a relay consensus attestation. The hold manager may verify that the sum of all active holds at an address does not exceed the tracked balance of the exchange medium before confirming placement.

In some embodiments, the hold manager 230 is configured to validate preconditions before accepting a hold. The hold manager may query ledger service 250 to confirm address existence, current balance of the exchange medium, and absence of conflicting holds against the same units. The hold manager may verify the reservation signature, check uniqueness of the reservation identifier, and record a nonce or sequence to prevent replay. When these checks succeed, the hold manager may persist the hold record in database engine 204 and publish a hold event through communication module 202 so peers can observe the state change.

In some embodiments, the hold manager 230 is configured to release holds only when cross network conditions are satisfied. The execution engine 220 may submit a release request that references a single fill and includes a relay proof bundle. The hold manager may consult relay consensus module 240 to evaluate the bundle, compute a maximum relay proof, and compare that maximum to a configured threshold. When the threshold is met or exceeded, the hold manager may update the on chain state to mark the hold released and authorize disbursement of the exchange medium to the destination address specified in the fill. If the threshold is not satisfied, the hold manager may maintain the active state and continue to observe updated proofs until the release condition becomes true or an invalidation rule applies.

In some embodiments, the hold manager 230 is configured to support partial fills and sequential disbursements. When the execution engine 220 publishes divisional fills that each consume a portion of a reservation, the hold manager may decrement the held amount atomically with each accepted fill and keep the residual amount locked. The hold manager may reject any fill that attempts to exceed the remaining held amount or that does not reference the correct authorization set. The hold manager may emit per fill release events so explorers and compliance tools can reconstruct the sequence of disbursements from durable logs.

In some embodiments, the hold manager 230 is configured to implement market volume based invalidation. The hold manager may read cumulative traded volume for the exchange medium from ledger service 250 and compare that measure to a reservation's volume threshold. When the threshold is met before release, the hold manager may clear the corresponding hold by updating the on chain state to return transferability to the owner and by marking the hold record cleared in database engine 204. The hold manager may publish an invalidation event so that matching stops against the affected reservation.

In some embodiments, the hold manager 230 is configured to harden settlement against reorganization and key compromise. If a chain reorganizes, the hold manager may recompute relay proofs via module 240 and refrain from release until the maximum again meets the threshold on the new history. Because the hold removes spend capability from the owner while active, compromise of the owner's private key alone may not move the held amount. The hold manager may also require both reservation and fill signatures and may confirm that the fill references the reservation identifier committed in the locking state.

In some embodiments, the hold manager 230 is configured to provide monitoring, recovery, and administrative interfaces. The hold manager may expose read only APIs to enumerate active, released, and cleared holds for a native address, may supply proofs that a given release adhered to the maximum relay proof condition, and may allow a wallet to request cancellation where protocol rules permit. Telemetry may include timestamps, chain heights, proof maxima observed, and state transitions, which the display module 216 may render to operators while the communication module 202 gossips the same events to peers for transparency.

In some embodiments, the relay consensus module 240 is configured to compute cross network confirmation evidence and to decide when protocol holds can be released for a fill. The module may run within application program 200 and interoperate with the execution engine 220 and the hold manager 230. It may ingest consensus outputs from at least a first blockchain network and a second blockchain network and produce a relay proof for each network together with a maximum relay proof used as the release condition.

In some embodiments, the relay consensus module 240 is configured to gather raw signals from participating blockchains and normalize them into comparable proof components. The module may subscribe to block headers, checkpoint certificates, validator attestations, and work difficulty summaries exposed by chain clients. For a proof of work chain, the module may derive a numeric contribution from cumulative difficulty across a selected depth and may confirm header linkage with standard cryptographic hashing. For a proof of stake chain, the module may derive a numeric contribution from the weight of signed validator votes, committee participation, and finality checkpoints, and may verify signatures against the active validator set. Each contribution may include metadata such as chain identifier, tip height, and an epoch counter so peers can detect stale or conflicting reports.

In some embodiments, the relay consensus module 240 is configured to compute per chain relay proofs and to combine them into a single scalar value that peers can compare without ambiguity. The module may apply a mapping that converts each chain's verified contribution into a normalized score and may sum or otherwise combine the scores according to a configured rule set. The result may be encoded as a relay proof bundle that carries the per chain components, the combined scalar, and compact witness material sufficient for independent verification by other nodes.

In some embodiments, the relay consensus module 240 is configured to run a lightweight agreement process that selects a maximum relay proof observed among peers. The module may gossip relay proof bundles, retain the largest verified scalar value M for the fill in progress, and treat M as authoritative when it meets or exceeds a release threshold T configured for the deployment. When M≥T, the module may emit a release signal to the hold manager 230 and the execution engine 220. When M<T, the module may continue to collect new bundles and update M until the threshold is met or an invalidation rule ends consideration of the fill.

In some embodiments, the relay consensus module 240 is configured to verify every received bundle before it influences the maximum. The module may check digital signatures on validator attestations, validate Merkle or accumulator proofs linking attestations to chain headers, and confirm that difficulty or stake weights match the referenced blocks and epochs. The module may reject bundles that replay obsolete epochs, that reference headers not on an acceptable fork choice, or that fail signature checks. Verification results may be cached to accelerate repeated evaluations across many fills.

In some embodiments, the relay consensus module 240 is configured to tolerate reorganization and asynchrony across chains. If a participating chain reorganizes, the module may recompute contributions on the new history and withdraw any bundle that no longer verifies. The module may avoid time based assumptions by relying solely on observed chain progress, so release decisions do not depend on wall clock deadlines. Peers that temporarily disconnect may rejoin by requesting recent bundles and by recomputing the current maximum from verifiable data.

In some embodiments, the relay consensus module 240 is configured to expose programmatic interfaces to upstream components. The execution engine 220 may call a propose interface with identifiers for the paired reservations and a candidate fill, after which the module begins gathering and gossiping proof bundles. The hold manager 230 may subscribe to an event that signals M≥T for a specific fill and may require the accompanying bundle as part of the release request. A query interface may return the current maximum, contributing components, and verification status so explorers and compliance systems can audit release decisions.

In some embodiments, the relay consensus module 240 is configured to onboard additional blockchains without altering upstream behavior. An operator may register a chain by providing a parser for its headers and attestations, a verification routine, and a normalization rule that maps verified progress to a numeric contribution. Once registered, the module may incorporate the new contribution into the combined scalar and into the gossiped bundles so future fills can consider the added chain.

In some embodiments, the relay consensus module 240 is configured to optimize performance and resource usage. The module may batch verification of attestations, pipeline header parsing, and apply memorization for repeated header ranges. It may compress bundles with canonical encodings and may limit gossip to deltas that increase the maximum. The module may maintain per fill state with compact indexes and may prune entries once the hold manager 230 confirms release or once a reservation becomes invalid under market volume rules.

In some embodiments, the relay consensus module 240 is configured to provide defensive monitoring and logging. The module may record the evolution of M for each fill, the threshold T in effect, the set of peers that supplied contributing bundles, and any verification failures encountered. These records may assist recovery after restart and may support post settlement audits that confirm that each release occurred only after independently verifiable cross network progress.

In some embodiments, the ledger service 250 is configured to maintain canonical records of balances, holds, fills, face value assignments, and reassignment events for the exchange medium across participating blockchains. The service may run within application program 200 and expose durable state to reservation subsystem 210, hold manager 230, execution engine 220, and relay consensus module 240. It may map each native address on a supported chain to an internal ledger entry that includes free balance of the exchange medium, active hold amounts keyed by reservation identifiers, cumulative filled amounts, and references to native asset movements that accompany a fill.

In some embodiments, the ledger service 250 is configured to model assignments that bind declared face value to a base cryptocurrency at a native address and to persist reassignments that migrate that face value between base cryptocurrencies. The service may represent an assignment as a tuple of chain identifier, base cryptocurrency identifier, native address, face value quantity, valuation model identifier, and lineage pointers. When the execution engine 220 requests a reassignment, the service may sequester or burn the source tuple and mint or free a destination tuple according to the valuation model while preserving an invariant that the total declared face value remains constant across chains. The service may emit an event stream so auditors can reconstruct the sequence that produced the current assignment graph.

In some embodiments, the ledger service 250 is configured to account for protocol holds and releases with transactional semantics. When reservation subsystem 210 posts a reservation, the service may atomically decrement free balance and increment a held balance bucket for the referenced native address. When hold manager 230 releases a portion due to a fill, the service may atomically move that portion from held to debited and record the counterparty credit on the destination address. These state transitions may be idempotent under a fill identifier so retries do not double count, and they may carry sequence numbers that protect against reordering during network delay.

In some embodiments, the ledger service 250 is configured to track market volume used for volume based invalidation. The service may maintain a rolling measure of cumulative traded volume for the exchange medium, update the measure when a fill finalizes, and expose the current value to reservation subsystem 210 and hold manager 230. When the measure meets or exceeds a reservation's threshold, the service may mark the reservation record invalid and provide a signal that allows the hold manager 230 to clear associated holds. A time independent volume counter may be computed per chain, per market pair, or system wide according to configuration.

In some embodiments, the ledger service 250 is configured to mirror on chain outcomes and to reconcile them with local intent. The service may subscribe to block receipts, event logs, and UTXO sets exposed by chain clients and apply deterministic rules that translate those artifacts into ledger updates. If a chain reorganizes, the service may roll back affected updates using append only logs and replay from the new canonical history. The service may only commit fills to finalized state after relay consensus module 240 provides a maximum proof that meets a threshold and hold manager 230 confirms release.

In some embodiments, the ledger service 250 is configured to index data for query, audit, and analytics. The service may maintain secondary indexes by reservation identifier, fill identifier, native address, chain height, and base cryptocurrency. Queries may return account statements for an address, a lineage trace for an assignment, or a reconciliation report that ties each release to the corresponding relay proof bundle and signatures. The service may produce Merkleized digests of ledger snapshots so external observers can verify inclusion of specific records without accessing raw databases.

In some embodiments, the ledger service 250 is configured to provide programmatic interfaces used by other modules and external tools. An internal API may return current balances, hold states, and eligibility flags required by the execution engine 220 when composing fills. A subscription interface may stream events such as reservation posted, hold placed, hold released, fill finalized, assignment created, and assignment sequestered. An external read only API may serve explorers and compliance systems that reconstruct market activity from emitted events without participating in matching or settlement.

In some embodiments, the ledger service 250 is configured to handle heterogeneous chain models. For account based chains, the service may cache contract storage slots that represent exchange medium balances and hold flags and may validate updates against emitted events. For UTXO based chains, the service may parse outputs tagged as exchange medium units, classify them as free or held based on locking scripts, and update local state when an output is spent by a valid fill. In both cases, the service may reconcile off chain intent with on chain confirmation so state remains consistent even when messages arrive out of order.

In some embodiments, the ledger service 250 is configured to secure data integrity and availability. The service may store records in append only logs and periodically checkpoint to immutable snapshots, which supports crash recovery through replay. It may sign snapshot digests to enable cross node verification and may replicate state across multiple storage backends. Access control may enforce least privilege for write paths from reservation subsystem 210 and hold manager 230 while allowing broad read access to audit interfaces.

In some embodiments, the ledger service 250 is configured to optimize performance for high message rates. The service may batch writes for fills included in the same block, apply lock free queues between ingest and persistence stages, and memorize common lookups such as current free balance for a hot address. It may compress historical records while keeping a hot working set in memory, and it may garbage collect transient artifacts after finality so steady state storage remains bounded.

In some embodiments, the ledger service 250 is configured to support diagnostics and recovery. The service may record causality links between reservations, holds, fills, relay proofs, and ledger effects so operators can reproduce the decision path for any transfer. If a node restarts, the service may rebuild in memory indexes from the append only log, reload the last consistent snapshot, and resume event emission without replaying completed fills. Through these mechanisms, the ledger service 250 supplies authoritative state that other modules use to enable atomic cross chain settlement, inter crypto face value migration, and transparent audit.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

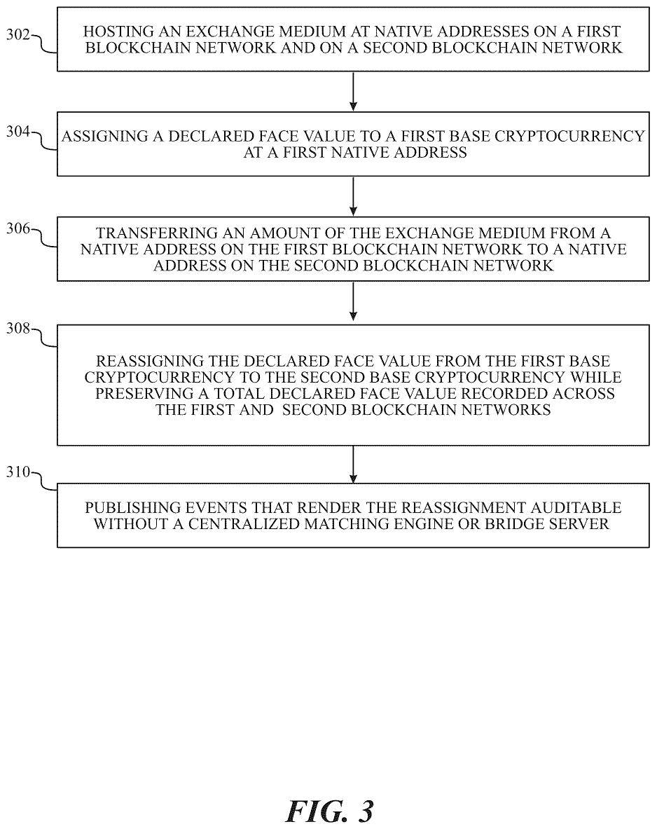

FIG. 3 illustrates a method for inter crypto face value migration and relocation executed by nodes of the disclosed system across a first blockchain network and a second blockchain network. At step 302, the system hosts an exchange medium at native addresses on both networks so ledger states for the exchange medium exist alongside native assets at those addresses. At step 304, the system assigns a declared face value to a first base cryptocurrency at a first native address, creating a recorded association between the face value and that base cryptocurrency. At step 306, the system transfers an amount of the exchange medium from a native address on the first blockchain network to a native address on the second blockchain network, preparing ledger context for cross network value movement. At step 308, the system reassigns the declared face value from the first base cryptocurrency to a second base cryptocurrency while preserving a total declared face value across the first and second blockchain networks. At step 310, the system publishes events that render the reassignment auditable without a centralized matching engine or bridge server, enabling independent verification from on chain artifacts.

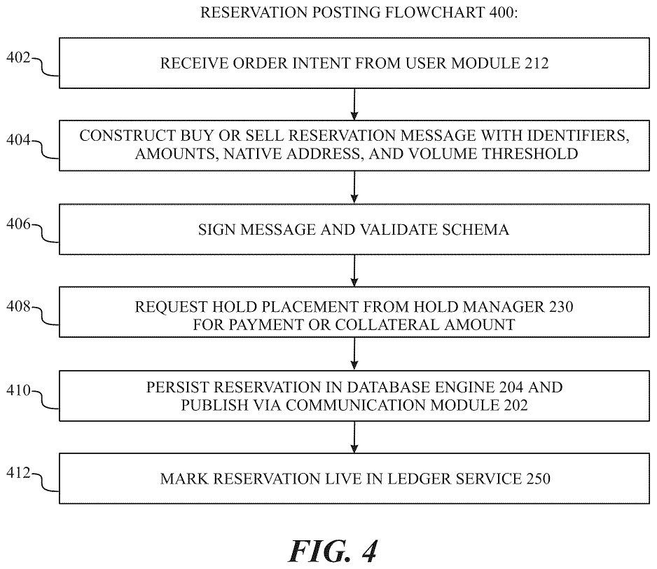

FIG. 4 illustrates a reservation posting flow executed by application program 200 to initiate exchange using the exchange medium. At step 402, user module 212 receives order intent from a wallet or operator and provides structured inputs that identify a desired trade, including a native address that hosts the exchange medium. At step 404, reservation subsystem 210 constructs a buy or sell reservation message that includes unique identifiers, amounts of the exchange medium to be held as payment or collateral, the native address, and a market volume threshold for expiration. At step 406, the subsystem signs the reservation with the operator's private key and validates the message schema, rejecting malformed or duplicate identifiers. At step 408, the subsystem requests hold manager 230 to place a protocol hold on the specified payment or collateral amount at the referenced native address so the amount becomes nontransferable by the owner while the reservation remains open. At step 410, database engine 204 persists the reservation in an append only record, and communication module 202 publishes the signed reservation to peers using chain native messaging so validators can discover it without a centralized routing server. At step 412, ledger service 250 marks the reservation live by debiting free balance of the exchange medium at the native address, crediting a held balance bucket keyed to the reservation identifier, and exposing the resulting state to matching and fill assembly. This sequence prepares a verifiable reservation that can participate in a single fill that later disburses the exchange medium and delivers a native asset with atomic settlement across participating blockchains.

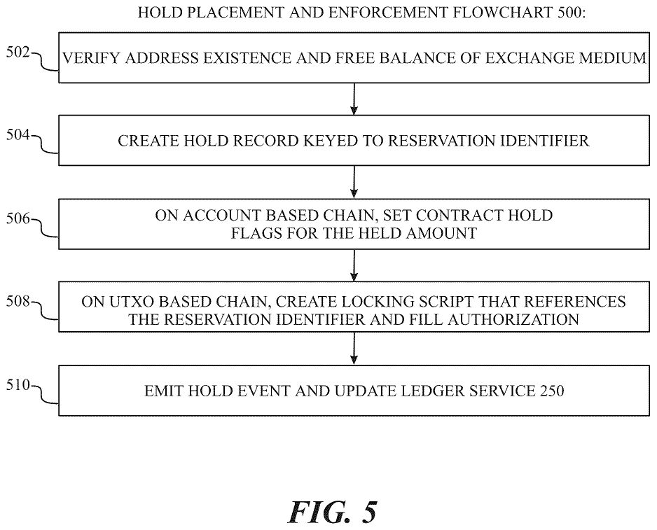

FIG. 5 illustrates a hold placement and enforcement flow performed by the hold manager 230 to restrict transferability of amounts of the exchange medium referenced by a posted reservation. At step 502, the hold manager 230 verifies existence of the referenced native address on the participating blockchain and reads the free balance of the exchange medium to confirm sufficiency for the requested hold. At step 504, the hold manager 230 creates a hold record keyed to the reservation identifier, the native address, and the amount to be restricted, and persists the record so later fills can reference the same units. At step 506, when the exchange medium resides on an account based chain, the hold manager 230 invokes a contract routine that sets hold flags for the identified amount, which removes owner driven transferability except through a release call that validates a corresponding fill. At step 508, when the exchange medium resides on a UTXO based chain, the hold manager 230 forms a locking script that commits to the reservation identifier and to a fill authorization path so the held units cannot move without a valid fill. At step 510, the hold manager 230 emits a hold event and instructs ledger service 250 to update state by decrementing free balance and incrementing a held balance bucket associated with the reservation, thereby making the held amount eligible for subsequent atomic settlement.

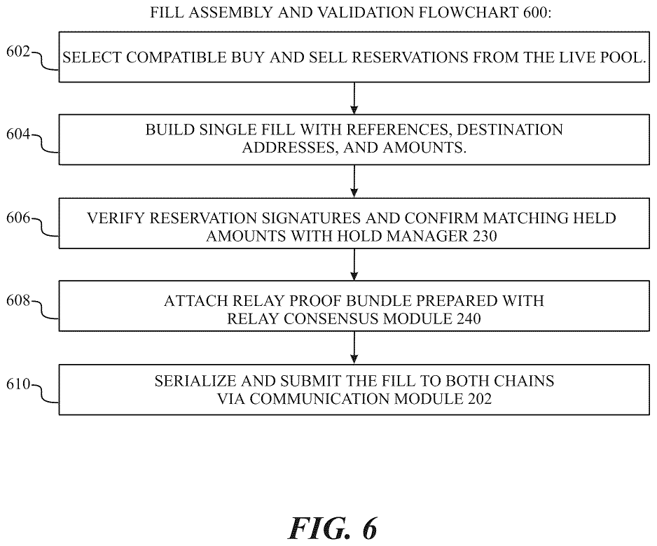

FIG. 6 illustrates a fill assembly and validation flow performed by application program 200 to consummate exchange between posted reservations. At step 602, the fill execution engine 220 selects compatible buy and sell reservations from the live pool maintained by the reservation subsystem 210 based on asset descriptors and available held amounts. At step 604, the fill execution engine 220 builds a single fill that references the selected reservations, specifies destination addresses for disbursement of the exchange medium and delivery of the native asset, and sets the corresponding amounts so the fill consumes only the eligible held balances. At step 606, the fill execution engine 220 verifies digital signatures on the reservations and consults the hold manager 230 to confirm that protocol holds exist at the referenced native addresses and that the held amounts match the proposed transfers. At step 608, the fill execution engine 220 attaches a relay proof bundle prepared with the relay consensus module 240 so validators can independently evaluate cross network confirmation progress against a configured release threshold. At step 610, the communication module 202 serializes the fill into chain native transactions or inbox messages and submits the fill to both participating blockchains, which enables subsequent release of the holds and atomic completion of disbursement and delivery when the relay consensus module 240 signals that the release condition is satisfied.

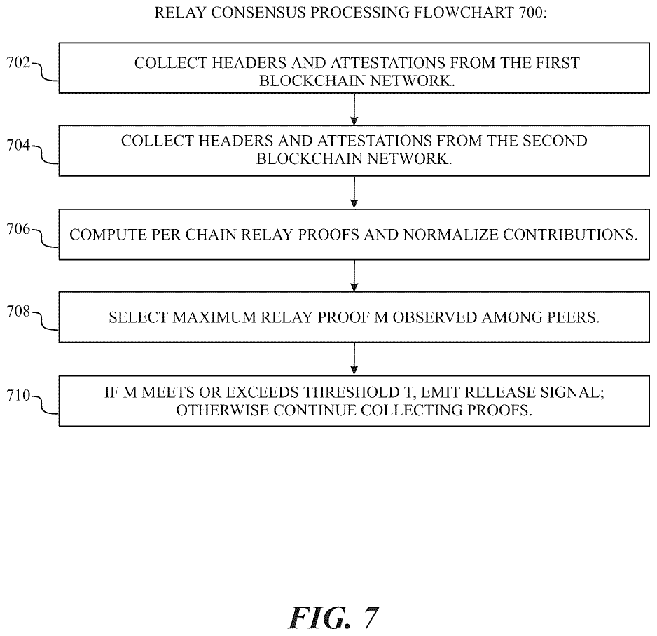

FIG. 7 illustrates a relay consensus processing flow executed by relay consensus module 240 to determine when protocol holds may be released for a fill. At step 702, the module collects headers and attestations from a first blockchain network by subscribing to block metadata, validator votes, and other consensus artifacts exposed by that network's client interfaces. At step 704, the module collects corresponding headers and attestations from a second blockchain network. For both networks, the module verifies signatures and linkages so only data that validates against the respective consensus rules contributes to later calculations. At step 706, the module computes per chain relay proofs and normalizes contributions into a common numeric scale. The module may derive a contribution from cumulative work or from weighted validator attestations, encode the contribution with chain identifier and epoch context, and produce a relay proof bundle that other nodes can verify independently. At step 708, the module exchanges relay proof bundles with peers and selects a maximum relay proof M observed for the fill in progress. At step 710, the module compares M to a configured threshold T. When M meets or exceeds T, the module emits a release signal to the hold manager 230 and the fill execution engine 220 so referenced holds may be released in support of atomic settlement. When M remains below T, the module continues to collect and evaluate additional proofs without relying on time locks or external orchestration.

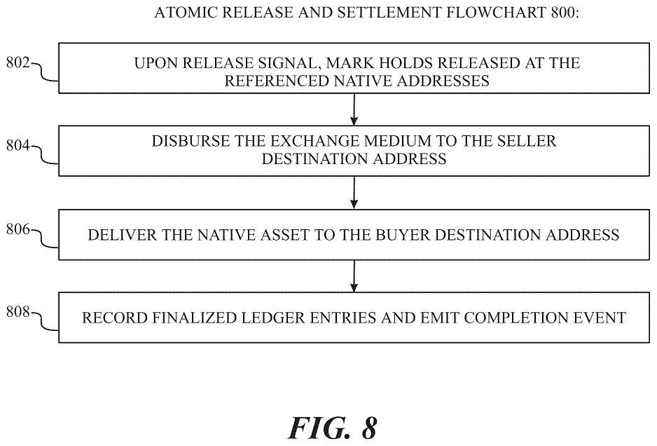

FIG. 8 illustrates an atomic release and settlement flow performed after relay consensus module 240 signals that a fill has satisfied a release threshold. At step 802, hold manager 230, in response to the release signal, marks the protocol holds referenced by the fill as released at the corresponding native addresses on the participating blockchains so owner transferability resumes only for the amounts authorized by the fill. At step 804, fill execution engine 220 disburses the exchange medium from the buyer's held balance to the seller destination address identified in the fill, using chain native transactions submitted through communication module 202. At step 806, fill execution engine 220 delivers the promised quantity of the native asset to the buyer destination address on the chain that hosts that asset, thereby completing the complementary leg of the trade in the same operation. At step 808, ledger service 250 records finalized ledger entries that debit held balances, credit destination balances, and update fill status, and emits a completion event that external observers can use to audit settlement without a centralized matching engine or bridge server.

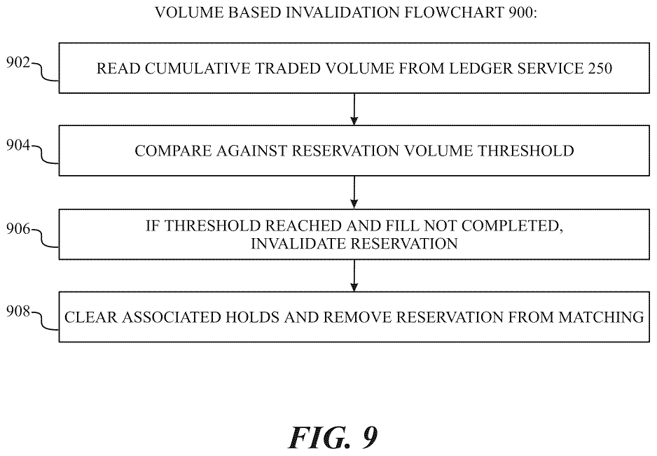

FIG. 9 illustrates a volume based invalidation flow executed to retire unmatched reservations without relying on wall clock timers. At step 902, ledger service 250 reads the current cumulative traded volume for the exchange medium according to the configured scope, which may be system wide, per chain, or per market pair. At step 904, reservation subsystem 210 compares the current cumulative volume to the volume threshold stored in the reservation record. At step 906, when the threshold has been reached and a corresponding fill has not completed, reservation subsystem 210 marks the reservation invalid so it no longer participates in matching. At step 908, hold manager 230 clears the protocol holds associated with the invalidated reservation by updating on chain state to return transferability of the previously held amount to the owner and by instructing ledger service 250 to remove the reservation from the live pool. This sequence maintains liveness during periods of high activity while preserving transparent audit through emitted state change events.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A crypto based monetary system of trade, comprising:
a first blockchain network;
a second blockchain network independent of the first blockchain network;
an exchange medium hosted at native addresses on the first blockchain network and on the second blockchain network;
validator nodes of the first and second blockchain networks configured to execute program instructions that maintain an assignment binding a declared face value to a base cryptocurrency at a native address, transfer the exchange medium between a native address on the first blockchain network and a native address on the second blockchain network, and reassign the declared face value from a first base cryptocurrency to a second base cryptocurrency while preserving a total declared face value recorded across the first and second blockchain networks and preserving a total book face value of the first and second base cryptocurrency maintained across the first and second blockchain networks; and
an order interface configured to receive orders that define movement of the exchange medium and native assets across the first and second blockchain networks without reliance on a time and order coincidental party, a trusted counterparty, or a trusted third party.

2. The system of claim 1, further comprising a protocol hold that marks an identified amount of the exchange medium at a native address as non transferable by its owner until a complementary transfer associated with an order is validated across the first and second blockchain networks.

3. The system of claim 2, wherein validation uses a relay consensus component configured to compute relay proof values on the first and second blockchain networks, to select a maximum relay proof that satisfies a release threshold, and to release the protocol hold only upon broadcast of the maximum relay proof and without employing hash time locked contracts.

4. The system of claim 1, wherein the orders comprise a buy reservation that locates a payment amount of the exchange medium at a selected native address and a sell reservation that locates a collateral amount of the exchange medium at a selected native address and binds a delivery quantity of a native asset, and wherein a single fill message simultaneously causes disbursement of the payment amount and delivery of the native asset.

5. The system of claim 4, wherein the single fill message is signed once and, when propagated by peers on the first and second blockchain networks, completes both transfers in one atomic act.

6. The system of claim 1, wherein each native address maintains an internal ledger that tracks balances for the exchange medium and for native assets and records state flags that indicate hold placement, release, and completed fills.

7. The system of claim 1, wherein an unmatched order expires when cumulative traded volume of the exchange medium reaches a market volume threshold specified in the order.

8. The system of claim 1, wherein orders are published and discovered by cryptographic wallets using peer to peer serverless messaging on the first and second blockchain networks and no off chain order routing server participates in matching or execution.

9. The system of claim 1, wherein the exchange medium and a native asset are commingled at a single smart contract address on at least one of the first and second blockchain networks.

10. The system of claim 1, wherein a wrapped token mirrors a native asset on at least one blockchain network while the exchange medium tracks independent balances at the same native address.

11. The system of claim 1, wherein the orders are matched and filled by multiple non preselected counterparties and across multiple non preselected addresses using sequential divisional fills.

12. A computer implemented method for inter crypto face value migration and relocation within a multi base crypto monetary system, the method comprising:
hosting an exchange medium at native addresses on a first blockchain network and on a second blockchain network;
assigning a declared face value to a first base cryptocurrency at a first native address;
receiving an order that requests relocation of value to a second base cryptocurrency;
transferring an amount of the exchange medium from a native address on the first blockchain network to a native address on the second blockchain network;
reassigning the declared face value from the first base cryptocurrency to the second base cryptocurrency while preserving a total declared face value recorded across the first and second blockchain networks; and
publishing events that render the reassignment auditable without a centralized matching engine or bridge server.

13. The method of claim 12, further comprising placing a protocol hold that renders the transferred amount of the exchange medium non transferable by its owner until a complementary transfer is validated across the first and second blockchain networks.

14. The method of claim 13, wherein validating includes computing relay proof values on the first and second blockchain networks, selecting a maximum relay proof that satisfies a configured release threshold, and releasing the protocol hold only upon broadcast of the maximum relay proof.

15. The method of claim 12, further comprising processing a buy reservation that locates a payment amount of the exchange medium at a selected native address, processing a sell reservation that locates a collateral amount of the exchange medium at a selected native address and binds a delivery quantity of a native asset, and executing a single fill message that simultaneously disburses the payment amount and delivers the native asset.

16. The method of claim 12, further comprising invalidating an unmatched order when cumulative traded volume of the exchange medium reaches a market volume threshold specified in the order.

17. The method of claim 12, further comprising assembling sequential divisional fills that match a single order against multiple non preselected counterparties and addresses.

18. A non transitory computer readable medium storing instructions that, when executed by one or more processors of nodes participating in a first blockchain network and a second blockchain network, cause the nodes to:
maintain an exchange medium at native addresses on each blockchain network;
bind a declared face value to a base cryptocurrency at a native address;
transfer the exchange medium between a native address on the first blockchain network and a native address on the second blockchain network in response to an order; and
reassign the declared face value from a first base cryptocurrency to a second base cryptocurrency while preserving a total declared face value recorded across the first and second blockchain networks.

19. The non transitory computer readable medium of claim 18, wherein the instructions further cause the nodes to compute relay proof values derived from at least one proof of work mechanism and at least one proof of stake mechanism, select a maximum relay proof that alone triggers release of a protocol hold tied to the order, and broadcast the maximum relay proof for synchronization.

20. The non transitory computer readable medium of claim 18, wherein the instructions further cause the nodes to accept digitally signed buy and sell reservations and to generate a single fill message that, when verified, simultaneously disburses an identified amount of the exchange medium and delivers a native asset between blockchain networks.
